(19) United States
(12) Patent Application Publication
(10) Pub. No.: US 2022/0146277 A1
(43) Pub. Date: May 12, 2022

(54) ARCHITECTURE FOR MAP CHANGE DETECTION IN AUTONOMOUS VEHICLES

(71) Applicant: Argo AI, LLC, Pittsburgh, PA (US)

(72) Inventors: John Lambert, Richmond, VA (US); James Hays, Decatur, GA (US); Francesco Ferroni, München (DE); Richard L. Kwant, San Bruno, CA (US)

(21) Appl. No.: 17/169,970

(22) Filed: Feb. 8, 2021

Related U.S. Application Data
(60) Provisional application No. 63/111,363, filed on Nov. 9, 2020.

(51) Int. Cl. G01C 21/00; G07C 5/08; G05B 13/02; G05D 1/02

(52) U.S. Cl. CPC G01C 21/3807; G07C 5/085; G01C 21/3833; G05D 1/0231; G05D 1/0276; G05B 13/027

(57) ABSTRACT

Methods by which an autonomous vehicle or related system may determine when a high definition (HD) map is out of date are disclosed. As the vehicle moves in an area, it captures sensor data representing perceived features of the area. A processor will input the sensor data along with HD map data for the area into a neural network to generate an embedding that identifies differences between features in the map data and corresponding features in the sensor data. The system may convert the sensor data into a birds-eye view or ego view before doing this. The network will identify any differences that exceed a threshold. The network will report the features for which the differences that exceed the threshold as features of the HD map that require updating.

### RELATED APPLICATIONS AND CLAIM OF PRIORITY

This patent document claims priority to U.S. provisional patent application No. 63/111,363, filed Nov. 9, 2020. The disclosure of the priority application is fully incorporated into this document by reference.

### BACKGROUND

To navigate in a real-world environment, autonomous vehicles (AVs) rely on high definition (HD) maps. An HD map is a set of digital files containing data about physical details of a geographic area such as roads, lanes within roads, traffic signals and signs, barriers, and road surface markings. An AV uses HD map data to augment the information that the AV's on-board cameras, LiDAR system and/or other sensors perceive. The AV's on-board processing systems can quickly search map data to identify features of the AV's environment and/or to help verify information that the AV's sensors perceive.

However, maps assume a static representation of the world. Because of this, over time, HD maps can become outdated. Map changes can occur due to new road construction, repaving and/or repainting of roads, road maintenance, construction projects that cause temporary lane changes and/or detours, or other reasons. In some geographic areas, HD maps can change several times per day, as fleets of vehicles gather new data and offload the data to map generation systems.

To perform path planning in the real world, and also to achieve Level 4 autonomy, an AV's on-board processing system needs to know when the HD map that it is using is out of date. In addition, operators of AV fleets and offboard map generation systems need to understand when data collected by and received from vehicles in an area indicate that an HD map for that area should be updated.

This document describes methods and systems that are directed to addressing the problems described above, and/or other issues.

### SUMMARY

This document describes methods by which an autonomous vehicle or related system may determine when a high definition (HD) map is out of date. As the vehicle moves in an area, it captures sensor data representing perceived features of the area. A processor will input the sensor data along with HD data for the area into a neural network (such as a convolutional neural network) to determine distances between features in the map data and corresponding features in the sensor data. For example, the network may compare differences between embeddings for each data set, or the network may directly generate scores for different categories corresponding to map-sensor agreement or disagreement. Either way, the system may convert the sensor data into a birds-eye view and/or ego view before doing this. The system will identify any distances or scores that exceed a threshold. The system may filter the features associated with such system so that only certain categories of features remain, or according to other criteria. The system will report the features for which the distances or scores that exceed the threshold, subject to any applied filters, as features of the HD map that require updating to a map generation system for updating the HD map, and/or to another system.

Accordingly, in some embodiments, a system for determining when an HD map is out of date includes a vehicle having one or more sensors, as well as an onboard computing system that includes a processor and a memory portion containing programming instructions. The system will access an HD map of an area in which the vehicle is present. The HD map includes map data about mapped features of the area that the vehicle can use to make decisions about movement within the area. A motion control system of the vehicle will cause the vehicle to move the vehicle about the area. The system will receive, from one or more of the sensors, sensor data that includes representations of perceived features of the area. The system will input the map data from the HD map and the sensor data captured by the perception system into a neural network to generate an embedding that provides differences between features in the map data and corresponding features in the sensor data. The system will identify any differences that exceed a threshold. The system will report the features for which the differences exceed the threshold as features of the HD map that require updating.

Before inputting the sensor data captured by the perception system into the neural network, the system may convert the sensor data into a birds-eye-view of the area and when inputting the sensor data into the neural network it may input the birds-eye view. To convert the sensor data into a birds-eye view, the system may accumulate multiple frames of sensor data that is LiDAR data, generate a local ground surface mesh of the area, and trace rays from the LiDAR data to the local ground surface mesh.

Before inputting the sensor data captured by the perception system into the neural network, the system may convert the sensor data into an ego view of the area, and when inputting the sensor data into the neural network the system may input the ego view.

Before inputting the sensor data captured by the perception system into the neural network, train the neural network on a set of simulated sensor data in which one or more annotated features of the area have been altered to not match corresponding features in the HD map data.

Optionally, before reporting the features, the system select a subset of the features for which the distances exceed the threshold. The subset may include and/or consist of features that correspond to one or more specified classes, or features for which the distances that exceed the threshold have been calculated at least a threshold number of times.

In some embodiments, the processor that will input the map data, identify the distances and report the features is a component of the onboard computing system of the vehicle. Alternatively, the processor that will input the map data, identify the distances and report the features is a component of a remote server is external to the vehicle, and if so the processor of the onboard computing system of the vehicle will transfer the sensor data to the remote server.

In addition, when inputting the map data from the HD map and the sensor data captured by the perception system into a neural network to identify differences, the system may generate a score that represents a probability of a change to a features in the map data. The system may identify any scores that exceed a scoring threshold, and it may report the features for which the scores exceed the scoring threshold as features of the HD map that require updating. Alternatively or in addition, the system may generate an embedding for each data set, and it may compare the embeddings to yield distances between the features in the map data and the corresponding features in the sensor data.

### BRIEF DESCRIPTION OF THE DRAWINGS

FIG. 1 is a high-level overview of various autonomous vehicle (AV) systems and subsystems.

FIG. 2 illustrates an example of features of an area that may be represented as a high definition (HD) map.

FIG. 3 illustrates an example process by which an AV or an external electronic device may assess whether an HD map is out of date.

FIG. 4 illustrates an example process by which a system may generate a birds-eye view of an area from sensor data.

FIG. 5 illustrates example systems and components of an autonomous vehicle.

FIG. 6 is a block diagram that illustrates various elements of a possible electronic subsystem of an autonomous vehicle and/or external electronic device.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

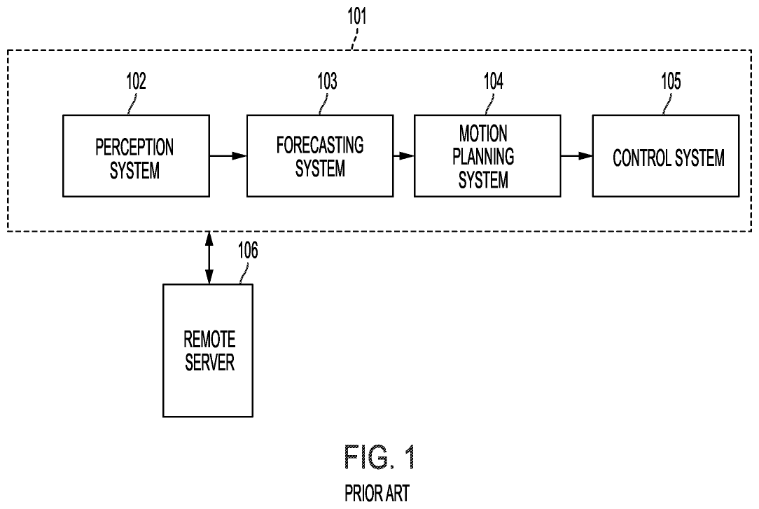

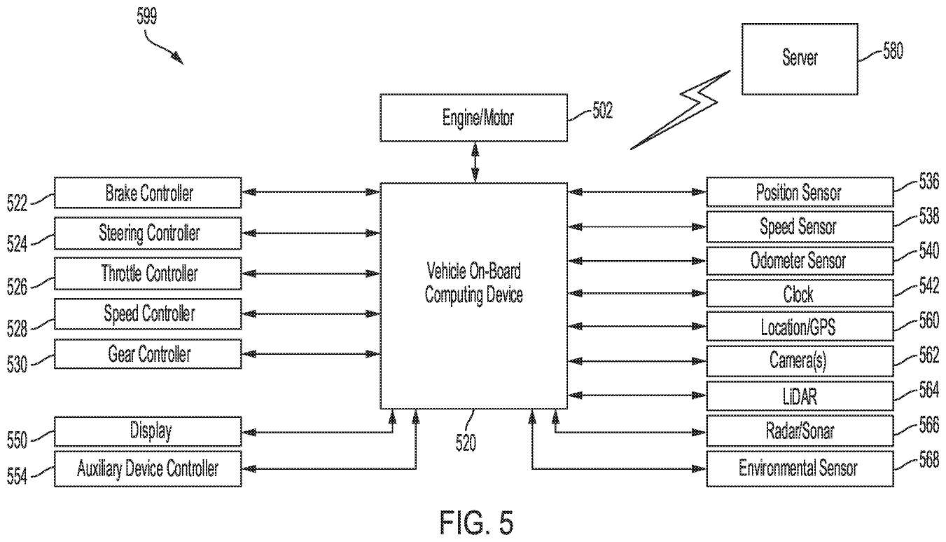

In the context of autonomous vehicle (AV) systems, “map change detection” is the process by which the AV determines whether a representation of the world, expressed as a map, matches the real world. Before describing the details of the map change detection processes, it is useful to provide some background information about AV systems. FIG. 1 shows a high-level overview of AV subsystems that may be relevant to the discussion below. Specific components within such systems will be described in the discussion of FIG. 5 later in this document. Certain components of the subsystems may be embodied in processor hardware and computer-readable programming instructions that are part of the AV's on-board computing system 101. The subsystems may include a perception system 102 that includes sensors that capture information about moving actors and other objects that exist in the vehicle's immediate surroundings. Example sensors include cameras, LiDAR sensors and radar sensors. The data captured by such sensors (such as digital image, LiDAR point cloud data, or radar data) is known as perception data.

The perception system may include one or more processors, and computer-readable memory with programming instructions and/or trained artificial intelligence models that, during a run of the AV, will process the perception data to identify objects and assign categorical labels and unique identifiers to each object detected in a scene. Categorical labels may include categories such as vehicle, bicyclist, pedestrian, building, and the like. Methods of identifying objects and assigning categorical labels to objects are well known in the art, and any suitable classification process may be used, such as those that make bounding box predictions for detected objects in a scene and use convolutional neural networks or other computer vision models. Some such processes are described in “Yurtsever et al., A Survey of Autonomous Driving: Common Practices and Emerging Technologies” (arXiv Apr. 2, 2020).

The vehicle's perception system 102 may deliver perception data to the vehicle's forecasting system 103. The forecasting system (which also may be referred to as a prediction system) will include processors and computer-readable programming instructions that are configured to process data received from the perception system and forecast actions of other actors that the perception system detects.

The vehicle's perception system, as well as the vehicle's forecasting system, will deliver data and information to the vehicle's motion planning system 104 and control system 104 so that the receiving systems may assess such data and initiate any number of reactive motions to such data. The motion planning system 103 and control system 104 include and/or share one or more processors and computer-readable programming instructions that are configured to process data received from the other systems, determine a trajectory for the vehicle, and output commands to vehicle hardware to move the vehicle according to the determined trajectory. Example actions that such commands may cause include causing the vehicle's brake control system to actuate, causing the vehicle's acceleration control subsystem to increase speed of the vehicle, or causing the vehicle's steering control subsystem to turn the vehicle. Various motion planning techniques are well known, for example as described in Gonzalez et al., “A Review of Motion Planning Techniques for Automated Vehicles,” published in IEEE Transactions on Intelligent Transportation Systems, vol. 17, no. 4 (April 2016).

During deployment of the AV, the AV receives perception data from one or more sensors of the AV's perception system. The perception data may include data representative of one or more objects in the environment. The perception system will process the data to identify objects and assign categorical labels and unique identifiers to each object detected in a scene.

The vehicle's on-board computing system 101 will be in communication with a remote server 106. The remote server 106 is an external electronic device that is in communication with the AV's on-board computing system 101, either via a wireless connection while the vehicle is making a run, or via a wired or wireless connection while the vehicle is parked at a docking facility or service facility. The remote server 106 may receive data that the AV collected during its run, such as perception data and operational data. The remote server 106 also may transfer data to the AV such as software updates, high definition (HD) map updates, machine learning model updates and other information.

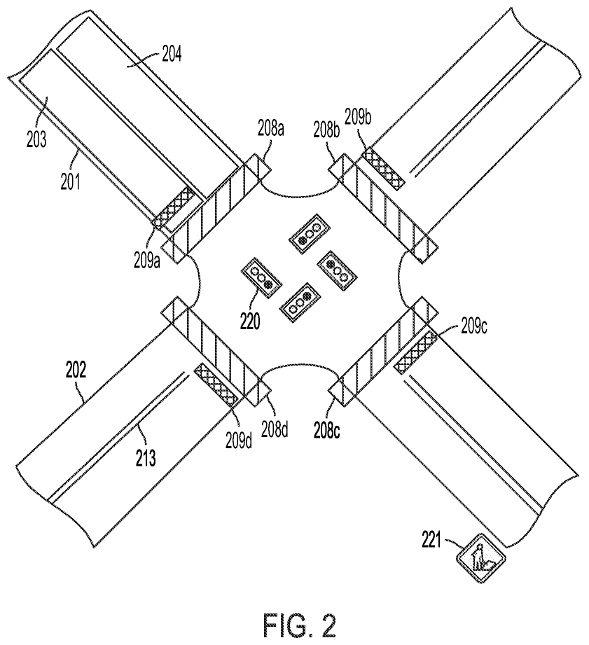

An HD map represents observable, physical objects in parametric representations. The objects contained in the HD map are those features of a driveable area that define the driveable area and provide information that an AV can use to make decisions about how to move about the driveable area. FIG. 2 illustrates an example illustration of HD map data for an intersection in which a first road 201 intersects with a second road 202. The geometry of each lane within each street may be represented as polygons such as lane polygons 203 and 204. Crosswalks 208a-208d and other road markings (such as double centerlines 213) may be represented as polylines or pairs of parallel polylines, while stop lines such as 209a-209b may be represented as polygons. Traffic lights 220 and traffic control signs 222 also may be represented as polygons. Some traffic control structures, such as road barriers or bollards (i.e., posts that divert traffic from a particular lane or area) may be represented as holes or other shapes in the map. The HD map will store this data, along with tags that label the data identifying the type of feature that the geometry represents (such as road construction sign, crosswalk, lane, etc.).

As noted above, map data such as that shown in FIG. 2 can become out of date as features of the environment change. For example, a road construction sign such as traffic control sign 222 may be installed or removed depending on when road crews are working in a particular location. A speed limit sign may change, or a stop sign may be replaced with a traffic signal. In addition, sometimes map data can be inaccurate, such as if a lane geometry is incorrect, or if a traffic control sign has been replaced (such as an updated speed limit sign that bears a new speed limit).

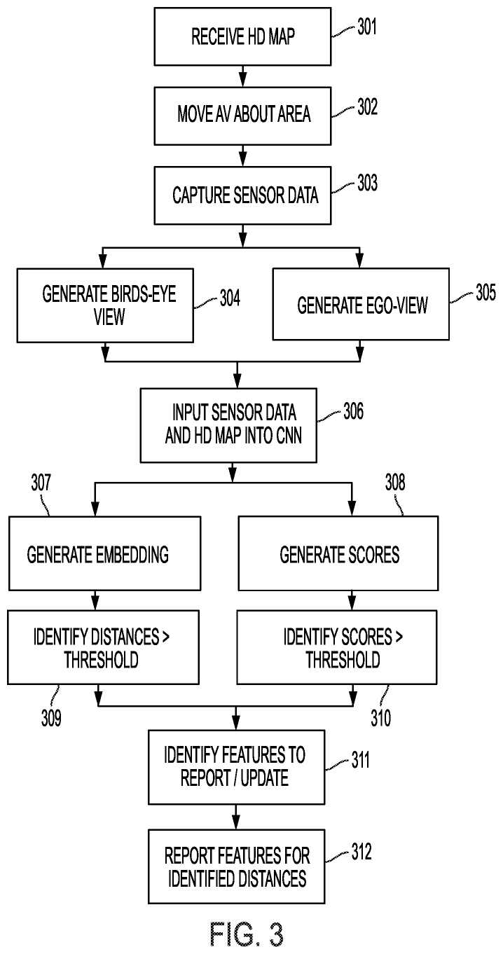

FIG. 3 illustrates a process by which an AV may gather data, and by which a processor that is onboard or external to the AV may use the data to assess whether an HD map is out of date. At 301 an onboard computing system of a vehicle will access an HD map of an area. The system may receive the HD map from a map generation system via a communication link, or the HD map may have previously been downloaded and stored in the AV's onboard memory prior to step 301. Example HD map datasets include that known as Argoverse, which at the time of this filing is available at argoverse.org, and which is described in Chang et al., “Argoverse: 3D Tracking and Forecasting with Rich Maps” (arXiv.org 2019). As noted above, the HD map will include map data about mapped features of the area that the vehicle can use to make decisions about movement within the area. At 302 the motion control system of the vehicle will cause the vehicle to move about the area, using the HD map to assist it in its motion planning. Example details of motion control systems and vehicle operation will be provided below. At 303 one or more sensors of a perception system of the vehicle will capture sensor data that includes representations of perceived features of the area. For example, the AV's LiDAR system may capture LiDAR data in which features of the area are represented in a three-dimensional point cloud, while the AV's cameras may capture digital image frames of the area.

At 306, a processor will input the map data from the HD map, along with the sensor data captured by the perception system, into a neural network. This processor may be on-board the vehicle, or it may be a processor of an off-board system to which the vehicle has transferred the sensor data. The neural network may be a convolutional neural network (CNN) or another multi-layer network that is trained to classify images and/or detect features within images.

Upon input of the map data and sensor data, the network may process the two and identify differences between the HD map data and the sensor data. For example, at 307 the system may generate an embedding for each data set and compare the embeddings to yield distances between features in the map data and corresponding features in the sensor data, and/or categorical scores as described below. Agreement scores or distances between map data and sensor data embeddings are determined by the network using algorithms and weights that the network has generated or otherwise learned during a training process, to perform a high-dimensional alignment between the input data and/or transformed versions of the input data. At training time, the system may determine whether or not the map and sensor data are in agreement by comparing the data and determining if changed map entities lie within some neighborhood of the egovehicle. For example, one may determine a value of the distance from the egovehicle to a sensed feature in the sensor data. If any egovehicle-to-changed map entity distance (point-to-point or point-to-line) falls below some threshold, the system may determine that in this local region the map is not in agreement with the real world. Processes by which the network will learn an embedding space will be described in more detail below.

As an alternative or in addition to generating distances between a map embedding and a sensor embedding, at step 308 the network may generate an n-dimensional output vector of scores, which can be normalized to represent probabilities of map-sensor agreement or disagreement over any number of categories. Examples of such categories may include “crosswalk change”, “no change”, “lane geometry change”, or any other category of map data that can change over time. To determine the score, the feature vectors of the HD map and the sensor data may be fed through a series of fully-connected neural network layers (weight matrices) to reduce their dimensionality to a low-dimensional vector of length n, in which n represents class probabilities. Alternatively, the system may use a binary classification system such as Siamese network (described below), or a trained discriminator in a generative adversarial network, which will classify features in the perception system's sensor data, compare those features to expected features in the HD map data, and report any features in the sensor data that deviate from the HD map features.

In either situation, before inputting the data at 306, the system may first convert the sensor data into a birds-eye view of the area (step 304), an ego-view of the area (step 305), or both. Then, at 306, the birds-eye view or ego-view of the sensor data may be stacked with the HD map data as input to an early-data-fusion model, or the two data streams (sensor data and HD map data) may be fed individually into separate networks in a late-data-fusion model, in which case high dimensional features would instead be concatenated for subsequent classification or regression.

As noted above, the embedding space generated in step 307 will provide distances between features in the map data and corresponding features in the sensor data. At 309 the system will identify any distances that exceed a threshold, optionally as a binary report (i.e., do they match or not), or as a score (i.e., a measure of the amount by which the distance exceeds the threshold). If the system generates scores, at 310 the system also may identify the generated scores that exceed a threshold. Alternatively or in addition, if the system associates confidence levels with each score, the system may only identify scores that exceed the threshold and that are associated with at least a minimum confidence level.

At 311 the system will report some or all of the features for which the distances or scores exceed the applicable threshold as features of the HD map that may require updating. The system may then update the map or transmit the report to a service that will update the map, whether automatically or with human annotation (or a combination of both). However, before reporting the features and updating the map, at 311 the system may first filter some of the threshold-exceeding features to report and update only those features that relate to a particular feature class (such as lane geometry and pedestrian crosswalks) as classified in at least the birds-eye view, or only those features for which threshold-exceeding distances are detected at least a minimum number of times within a time horizon or within a number of vehicle runs.

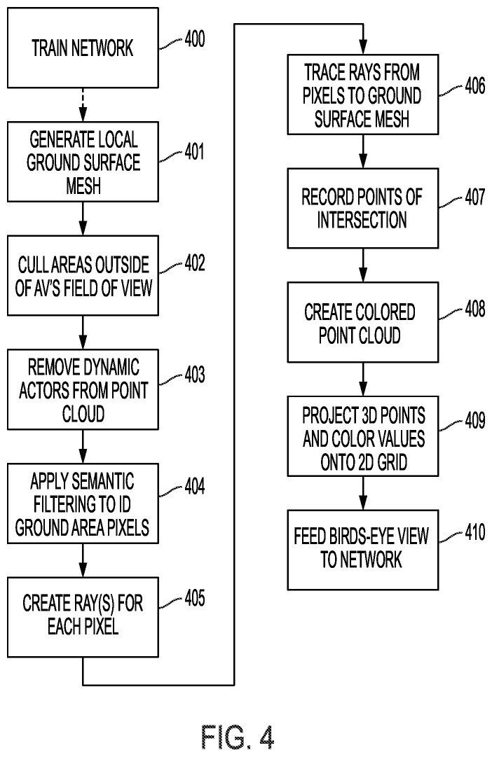

FIG. 4 illustrates details about how the system may convert the sensor data into a birds-eye view (i.e., step 304 of FIG. 3). The system may start with a ground surface mesh of the area. At 401 the system may generate the local ground surface mesh from the three dimensional (3D) point cloud of collected LiDAR data, with the mesh providing three-dimensional details of the egovehicle-proximate terrain that includes the ground surface and that extends up to a threshold distance above the ground surface. The local ground surface mesh may be stored as part of the HD map and loaded, or otherwise generated by or retrieved into the system. Alternatively, ground surface height data may be included in the HD map (from previously collected data rather than real-time onboard measurements), and then a small portion of that surface data (i.e., a portion in the area of the AV's position) would be used to define the 3D ground surface mesh. The system may accumulate multiple frames of point cloud data. Optionally, at this point or after any step in the process before completing the birds-eye view, at 402 the system may cull any sub-polygons that are outside of the field of view of the vehicle's sensors, so that the birds-eye view only includes the area that is detectable by the vehicle. Also, optionally, at any point in the process such as 403 the system may remove any streaks within the data that represent dynamic objects—i.e., moving actors that are not static features of the environment.

At 404 the system may then apply a semantic filtering model to the data to identify pixels in the image that correspond to ground surface areas. An example suitable semantic filtering process is disclosed in Lambert et al., “MSeg: A Composite Dataset for Multi-Domain Semantic Segmentation” (2020), in which the MSeg composite dataset is used to train a semantic segmentation model. After the pixels have been identified, then at 405 the system will create a set of rays out for some or all of the pixels that correspond to a ground area by generating at least one ray per identified pixel.

At 406 the system may then trace the rays for each pixel from the camera to the ground mesh. To do this, the system may tessellate the mesh with a set of polygons, such as four quadrants, and it may further tessellate the polygons into smaller sub-polygons, such as a pair of triangles for each quadrant. The system may then trace rays from each sub-polygon to any feature that is within a threshold distance above the ground surface (such as up to 10 meters, 15 meters, 20, or 25 meters). Any suitable ray tracing algorithm may be used, such as the Möller-Trumbore triangle-ray tracing algorithm, as disclosed on Möller and Trumbore, “Fast, Minimum Storage Ray-Triangle Intersection”, Journal of Graphics Tools 2: 21-28 (1997).

At 407 the system will record the points of intersection. For example, the system may send out a single 3D ray per pixel of the image and record the 3D point (that is, the x, y, z coordinate) at which the AV intersects with the local ground surface triangle mesh. At 408 the system will create a colored point cloud from the 3D intersection points. To do this, the system may send out a single 3D ray per pixel of the image, determine the RGB value of that the camera recorded for the pixel, and assign that RGB value to the pixel at the point of intersection (as determined in step 407) for that ray. At 409 the system will form the bird's-eye view image by projecting the 3D points and their color values onto a 2D grid. Finally, at 410 the system may feed the birds-eye view into the network that was pre-trained at 400.

While the example of FIG. 4 uses LiDAR point cloud data to generate the birds-eye view, the system could perform similar analysis to identify and label features of an environment that are captured by the AV's camera system, and using such features to generate the birds-eye view.

Generation of the ego-view (step 305 in FIG. 3) may similarly be done from camera data and/or LiDAR data captured by the AV. The ego view is simply the head on view as seen by the vehicle's sensors, viewed from the perspective of the vehicle. Methods by which an AV's perception system may classify objects are described above in the context of FIG. 1.

The architecture of the neural network into which the system inputs sensor data and HD map data may be a two-tower architecture, which is sometimes referred to as a Siamese neural network or a twin neural network. Such an architecture can examine each data stream independently and concurrently, so that the system can identify features within each data set and then compare the two data sets after identifying the features. The system may look for binary differences in feature classification (i.e., by determining whether the labels of the features match or do not match), or it may look for other measurable differences in feature classification. For example, the system may first consider whether the feature labels match or not, and if they do not match the system may then the system may determine a type of mismatch to assess whether the feature has changed in a way that warrants updating the map. By way of example: A stoplight that has been replaced with a device that adds a left turn arrow may not warrant a map update. However, if a speed limit sign has been replaced, a change will be warranted if the actual speed limit shown on the sign has changed.

In some embodiments, as shown in the top of FIG. 4, before the network is used to receive actual sensor data and to generate embeddings, at 400 the network may be trained on simulated (i.e., synthetic) sensor data. A network is typically trained on sensor data captured by vehicles as they move throughout an area. However, certain changes may only occur rarely. For example, new traffic signals are not frequently installed, and existing traffic signals are infrequently removed and replaced. Therefore, an automated system or human operator may generate simulated training data, comprising simulated images or modified actual images in which certain features (such as traffic signals and traffic control signs) have been added, removed or changed. Annotations (labels) will be included for each of these features in the training data. The neural network may be trained on a dataset of this simulated data before it is used to generate embeddings from actual sensor data taken during real-world runs of the vehicle. The training data set may be, for example, in the form of triplets {x, x*, y} in which x is a local region of the map, x* is an online sensor sweep, and y is a binary label indicating whether a significant map change occurred (i.e., whether at least a threshold difference in distance between map and sensor data is present). In this example, {x, x*} should correspond to the same geographic location.

In some embodiments, the training elements of the system may use an adversarial approach to train both the map validation system and the map generation system. For example, a map generation network (serving as a generator) may provide the HD map that is input into the AV and/or the neural network. The network that generates the embedding may then serve as a discriminator that compares the sensor data with the HD map data. The output from the discriminator can be input into the generator to train the map generation network, and vice versa, so that the discriminator is used as a loss function for the generator, and the generator outputs can be used to train the discriminator.

An example implementation of the processes listed above is now described. An AV may access an HD map, rendered as rasterized images. Entities may be labeled (i.e., assigned classes) from the back of the raster to the front in an order such as: driveable area; lane segment polygons, lane boundaries; and pedestrian crossings (crosswalks). Then, as the AV moves through a drivable area, the AV may generate new orthoimagery each time the AV moves at least a specified distance (such as 5 meters). To prevent holes in the orthoimagery under the AV, the system may aggregate pixels in a ring buffer over a number of sweeps (such as 10 sweeps), then render the orthoimagery. The system may then tessellate quads from a ground surface mesh with, for example, 1 meter resolution to triangles. The system may cast rays to triangles up to, for example, 25 meters from the AV. For acceleration, the system may cull triangles outside of left and right cutting planes of each camera's view frustum. The system may determine distances from the AV to the labeled entities, and compare the distances as found in each sensor data asset.

FIG. 5 illustrates an example system architecture 599 for a vehicle, such as an AV. The vehicle includes an engine or motor 502 and various sensors for measuring various parameters of the vehicle and/or its environment. Operational parameter sensors that are common to both types of vehicles include, for example: a position sensor 536 such as an accelerometer, gyroscope and/or inertial measurement unit; a speed sensor 538; and an odometer sensor 540. The vehicle also may have a clock 542 that the system uses to determine vehicle time during operation. The clock 542 may be encoded into the vehicle on-board computing device, it may be a separate device, or multiple clocks may be available.

The vehicle also will include various sensors that operate to gather information about the environment in which the vehicle is traveling. These sensors may include, for example: a location sensor 560 such as a global positioning system (GPS) device; object detection sensors such as one or more cameras 562; a LiDAR sensor system 564; and/or a radar and or and/or a sonar system 566. The sensors also may include environmental sensors 568 such as a precipitation sensor and/or ambient temperature sensor. The object detection sensors may enable the vehicle to detect moving actors and stationary objects that are within a given distance range of the vehicle 599 in any direction, while the environmental sensors collect data about environmental conditions within the vehicle's area of travel. The system will also include one or more cameras 562 for capturing images of the environment. Any or all of these sensors will capture sensor data that will enable one or more processors of the vehicle's on-board computing device 520 and/or external devices to execute programming instructions that enable the computing system to classify objects in the perception data, and all such sensors, processors and instructions may be considered to be the vehicle's perception system. The vehicle also may receive information from a communication device (such as a transceiver, a beacon and/or a smart phone) via one or more wireless communication link, such as those known as vehicle-to-vehicle, vehicle-to-object or other V2X communication links. The term “V2X” refers to a communication between a vehicle an any object that the vehicle that may encounter or affect in its environment.

During a run of the vehicle, information is communicated from the sensors to an on-board computing device 520. The on-board computing device 520 analyzes the data captured by the perception system sensors and, acting as a motion planning system, executes instructions to determine a trajectory for the vehicle. The trajectory includes pose and time parameters, and the vehicle's on-board computing device will control operations of various vehicle components to move the vehicle along the trajectory. For example, the on-board computing device 520 may control braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions); and/or other controllers.

Geographic location information may be communicated from the location sensor 560 to the on-board computing device 520, which may then access a map of the environment that corresponds to the location information to determine known fixed features of the environment such as streets, buildings, stop signs and/or stop/go signals. Captured images from the cameras 562 and/or object detection information captured from sensors such as a LiDAR system 564 is communicated from those sensors) to the on-board computing device 520. The object detection information and/or captured images may be processed by the on-board computing device 520 to detect objects in proximity to the vehicle 500. In addition or alternatively, the AV may transmit any of the data to an external server 580 for processing. Any known or to be known technique for performing object detection based on sensor data and/or captured images can be used in the embodiments disclosed in this document.

In addition, the AV may include an onboard display device ### that may generate and output interface on which sensor data, vehicle status information, or outputs generated by the processes described in this document are displayed to an occupant of the vehicle. The display device may include, or a separate device may be, an audio speaker that presents such information in audio format.

In the various embodiments discussed in this document, the description may state that the vehicle or on-board computing device of the vehicle may implement programming instructions that cause the on-board computing device of the vehicle to make decisions and use the decisions to control operations of one or more vehicle systems. However, the embodiments are not limited to this arrangement, as in various embodiments the analysis, decisionmaking and or operational control may be handled in full or in part by other computing devices that are in electronic communication with the vehicle's on-board computing device. Examples of such other computing devices include an electronic device (such as a smartphone) associated with a person who is riding in the vehicle, as well as a remote server that is in electronic communication with the vehicle via a wireless communication network.

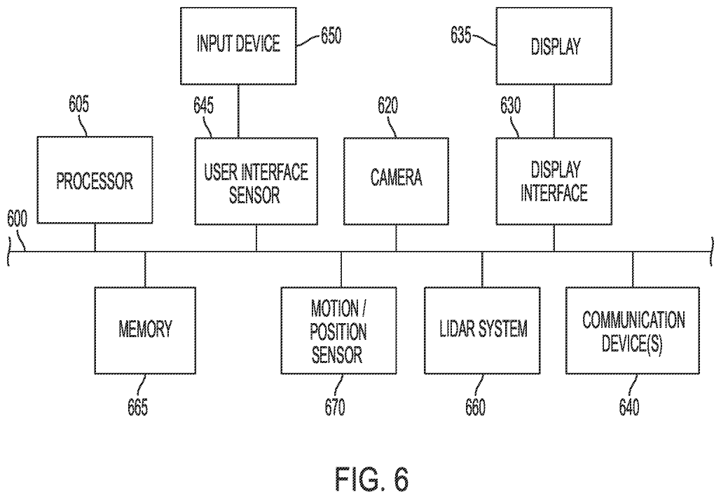

FIG. 6 depicts an example of internal hardware that may be included in any of the electronic components of the system, such as internal processing systems of the AV, external monitoring and reporting systems, or remote servers. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 625. A memory device may include a single device or a collection of devices across which data and/or instructions are stored. Various embodiments of the invention may include a computer-readable medium containing programming instructions that are configured to cause one or more processors to perform the functions described in the context of the previous figures.

An optional display interface 630 may permit information from the bus 600 to be displayed on a display device 635 in visual, graphic or alphanumeric format, such on an in-dashboard display system of the vehicle. An audio interface and audio output (such as a speaker) also may be provided. Communication with external devices may occur using various communication devices 640 such as a wireless antenna, a radio frequency identification (RFID) tag and/or short-range or near-field communication transceiver, each of which may optionally communicatively connect with other components of the device via one or more communication system. The communication device(s) 640 may be configured to be communicatively connected to a communications network, such as the Internet, a local area network or a cellular telephone data network.

The hardware may also include a user interface sensor 645 that allows for receipt of data from input devices 650 such as a keyboard or keypad, a joystick, a touchscreen, a touch pad, a remote control, a pointing device and/or microphone. Digital image frames also may be received from a camera 620 that can capture video and/or still images. The system also may receive data from a motion and/or position sensor 670 such as an accelerometer, gyroscope or inertial measurement unit. The system also may receive data from a LiDAR system 960 such as that described earlier in this document.

The features and functions disclosed above, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

Terminology that is relevant to the disclosure provided above includes:

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions. Alternatively, it may be semi-autonomous in that a human operator may be required in certain conditions or for certain operations, or that a human operator may override the vehicle's autonomous system and may take control of the vehicle. Autonomous vehicles also include vehicles in which autonomous systems augment human operation of the vehicle, such as vehicles with driver-assisted steering, speed control, braking, parking and other advanced driver assistance systems.

The term “ego-vehicle” refers to a particular vehicle that is moving in an environment. When used in this document, the term “ego-vehicle” generally refers to an AV that is moving in an environment, with an autonomous vehicle control system (AVS) that is programmed to make decisions about where the AV will or will not move.

A “run” of a vehicle refers to an act of operating a vehicle and causing the vehicle to move about the real world. A run may occur in public, uncontrolled environments such as city or suburban streets, highways, or open roads. A run may also occur in a controlled environment such as a test track.

In this document, the terms “street,” “lane,” “road” and “intersection” are illustrated by way of example with vehicles traveling on one or more roads. However, the embodiments are intended to include lanes and intersections in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” or “road” may represent an airway and a lane may be a portion of the airway. If the autonomous vehicle is a watercraft, then the term “street” or “road” may represent a waterway and a lane may be a portion of the waterway.

An “electronic device”, “server” or “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices. A “memory portion” is one or more areas of a memory device or devices on which programming instructions and/or data are stored.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The term “classifier” means an automated process by which an artificial intelligence system may assign a label or category to one or more data points. A classifier includes an algorithm that is trained via an automated process such as machine learning. A classifier typically starts with a set of labeled or unlabeled training data and applies one or more algorithms to detect one or more features and/or patterns within data that correspond to various labels or classes. The algorithms may include, without limitation, those as simple as decision trees, as complex as Naïve Bayes classification, and/or intermediate algorithms such as k-nearest neighbor. Classifiers may include artificial neural networks (ANNs), support vector machine classifiers, and/or any of a host of different types of classifiers. Once trained, the classifier may then classify new data points using the knowledge base that it learned during training. The process of training a classifier can evolve over time, as classifiers may be periodically trained on updated data, and they may learn from being provided information about data that they may have mis-classified. A classifier will be implemented by a processor executing programming instructions, and it may operate on large data sets such as image data, LIDAR system data, and/or other data.

In this document, when relative terms of order such as “first” and “second” are used to modify a noun, such use is simply intended to distinguish one item from another, and is not intended to require a sequential order unless specifically stated.

1. A method of determining when a high definition (HD) map is out of date, the method comprising:
by an onboard computing system of a vehicle, accessing an HD map of an area around the vehicle, wherein the HD map includes map data about mapped features of the area that the vehicle can use to make decisions about movement within the area;
by a motion control system of the vehicle, causing the vehicle to move about the area;
by one or more sensors of a perception system of the vehicle, capturing sensor data that includes representations of perceived features of the area;
by a processor:
inputting the map data from the HD map and the sensor data captured by the perception system into a neural network to identify differences between features in the map data and corresponding features in the sensor data,
identifying any differences that exceed a threshold,
reporting the features for which the differences exceed the threshold as features of the HD map that require updating.

2. The method of claim 1 further comprising:
by the processor before inputting the sensor data captured by the perception system into the neural network, converting the sensor data into a birds-eye-view of the area,
wherein inputting the sensor data into the neural network comprises inputting the birds-eye view.

3. The method of claim 2, wherein converting the sensor data into a birds-eye view comprises:
accumulating a plurality of frames of sensor data that is LiDAR data;
generating a local ground surface mesh of the area; and
tracing a plurality of rays from the LiDAR data to the local ground surface mesh;

4. The method of claim 1 further comprising:
by the processor before inputting the sensor data captured by the perception system into the neural network, converting the sensor data into an ego view of the area,
wherein inputting the sensor data into the neural network comprises inputting the ego view.

5. The method of claim 1 further comprising, by the processor before inputting the sensor data captured by the perception system into the neural network, training the neural network on a set of simulated sensor data in which one or more annotated features of the area have been altered to not match corresponding features in the HD map data.

6. The method of claim 1 further comprising, by the processor, reporting the features of the HD map that require updating to a map generation system for updating the HD map.

7. The method of claim 1 further comprising, before reporting the features, selecting a subset of the features for which the distances exceed the threshold, wherein the subset comprises:
features that correspond to one or more specified classes; or
features for which the distances that exceed the threshold have been calculated at least a threshold number of times.

8. The method of claim 1, wherein:
the processor comprises a processor that is a component of a remote server is external to the vehicle; and
the method further comprises, by the onboard computing system of the vehicle, transferring the sensor data to the remote server.

9. The method of claim 1, wherein inputting the map data from the HD map and the sensor data captured by the perception system into a neural network to generate an embedding that determines distances between features in the map data and corresponding features in the sensor data,
inputting the map data from the HD map and the sensor data captured by the perception system into a neural network to generate a score that represents a probability of a change to a features in the map data;
identifying any scores that exceed a scoring threshold; and
when reporting the features for which the differences exceed the threshold as features of the HD map that require updating, reporting the features for which the scores exceed the scoring threshold.

10. The method of claim 1, wherein inputting the map data from the HD map and the sensor data captured by the perception system into a neural network to identify differences between features in the map data and corresponding features in the sensor data comprises:
generating an embedding for each data set; and
comparing the embeddings to yield distances between the features in the map data and the corresponding features in the sensor data.

11. A system for determining when a high definition (HD) map is out of date, the system comprising:
a vehicle having one or more sensors, an onboard computing system that comprises a processor, and a memory portion containing programming instructions that, when executed, will cause the processor to:
access an HD map of an area in which the vehicle is present, wherein the HD map includes map data about mapped features of the area that the vehicle can use to make decisions about movement within the area,
cause a motion control system of the vehicle to move the vehicle about the area;
receive, from the one or more sensors, sensor data that includes representations of perceived features of the area; and
a memory portion containing additional programming instructions that are configured to cause the processor or another processor to:
input the map data from the HD map and the sensor data captured by the perception system into a neural network to generate identify differences between features in the map data and corresponding features in the sensor data,
identify any differences that exceed a threshold, and
report the features for which the differences exceed the threshold as features of the HD map that require updating.

12. The system of claim 11 further comprising instructions to cause one or more of the processors to:
before inputting the sensor data captured by the perception system into the neural network, convert the sensor data into a birds-eye-view of the area; and
when inputting the sensor data into the neural network, input the birds-eye view.

13. The system of claim 12, wherein the instructions to convert the sensor data into a birds-eye view comprise instructions to:
accumulate a plurality of frames of sensor data that is LiDAR data;
generate a local ground surface mesh of the area; and
trace a plurality of rays from the LiDAR data to the local ground surface mesh;

14. The system of claim 11 further comprising instructions to cause one or more of the processors to:
before inputting the sensor data captured by the perception system into the neural network, convert the sensor data into an ego view of the area; and
when inputting the sensor data into the neural network, input the ego view.

15. The system of claim 11 further comprising instructions to cause one or more of the processors to, before inputting the sensor data captured by the perception system into the neural network, train the neural network on a set of simulated sensor data in which one or more annotated features of the area have been altered to not match corresponding features in the HD map data.

16. The system of claim 11 further comprising instructions to cause one or more of the processors to report the features of the HD map that require updating to a map generation system for updating the HD map.

17. The system of claim 11 further comprising instructions to cause one or more of the processors to, before reporting the features, select a subset of the features for which the distances exceed the threshold, wherein the subset comprises:
features that correspond to one or more specified classes; or
features for which the distances that exceed the threshold have been calculated at least a threshold number of times.

18. The system of claim 11, wherein the processor that will input the map data, identify the distances and report the features is a component of the onboard computing system of the vehicle.

19. The system of claim 11, wherein:
the processor that will input the map data, identify the distances and report the features is a component of a remote server is external to the vehicle; and
the system further comprises instructions to cause the processor of the onboard computing system of the vehicle to transfer the sensor data to the remote server.

20. The system of claim 11 wherein:
the instructions that are configured to cause one or more of the processors to input the map data from the HD map and the sensor data captured by the perception system into a neural network to identify differences between features in the map data and corresponding features in the sensor data comprise instructions to:
input the map data from the HD map and the sensor data captured by the one or more sensors into a neural network to generate a score that represents a probability of a change to a features in the map data, and
identify any scores that exceed a scoring threshold; and
the instructions that are configured to cause one or more of the processors to report the features for which the differences exceed the threshold as features of the HD map that require updating comprise instructions to report the features for which the scores exceed the scoring threshold.

21. The system of claim 11 wherein the instructions that are configured to cause one or more of the processors to input the map data from the HD map and the sensor data captured by the perception system into a neural network to identify differences between features in the map data and corresponding features in the sensor data comprise instructions to:
generate an embedding for each data set; and
compare the embeddings to yield distances between the features in the map data and the corresponding features in the sensor data.
